(19) United States
(12) Patent Application Publication
(10) Pub. No.: US 2026/0133885 A1
(43) Pub. Date: May 14, 2026

(54) SYSTEMS AND METHODS FOR ARTIFICIAL INTELLIGENCE BASED ERROR RESOLUTION, MONITORING, AND ALERTING

(71) Applicant: Ponchos & Huaraches, Inc. dba harpin.AI, Bend, OR (US)

(72) Inventors: Scott Sebastian Sahadi, Solana Beach, CA (US); Wenzhong Zhao, San Diego, CA (US); Eric Scheie, La Mesa, CA (US); Steven Ratay, Lake Forest, IL (US); Jack Vessa, San Francisco, CA (US)

(21) Appl. No.: 18/942,212

(22) Filed: Nov. 8, 2024

(51) Int. Cl. G06F 11/34; G06F 11/32

(52) U.S. Cl. CPC G06F 11/3447; G06F 11/327

(57) ABSTRACT

Systems and methods for error resolution are disclosed herein. The systems and methods may monitor an identity dataset associated with one or more entities. The systems and methods may generate a normalized dataset based on the identity dataset and an input format associated with a trained machine learning model. The systems and methods may process the normalized dataset using the trained machine learning model to identify one or more errors within the normalized dataset. The systems and methods may generate a data quality score for the normalized dataset based on the one or more errors identified within the normalized dataset using the trained machine learning model. The systems and methods may output the data quality score for the normalized dataset.

### TECHNICAL FIELD

This disclosure is related to resolving errors in datasets using Artificial Intelligence (AI) models (e.g., machine-learning (ML) models and/or large language models (LLMs)). In particular, this disclosure relates to systems and methods for AI based error resolution, monitoring, and alerting that permits datasets to be monitored for errors, those errors to be resolved and corrected, and alerts to be provided regarding the identified and/or resolved errors.

### BACKGROUND

Error resolution is a critical component of many different data-related services, including but not limited to customer services (e.g., call center services, customer support services, etc.), data processing services, and any business, organization, or entity that relies on accurate data to provide a good and/or service. In particular, error resolution provides a way for identifying and correcting errors in datasets, thereby improving the quality of the data that is ingested into a system. However, error resolution is a very difficult task for a number of reasons. For example, the complexity and size of the data being monitored or ingested creates computational hurdles for error resolution, especially when the datasets are sourced from different, unrelated data sources having their own unique data formats and variations in the different types of data captured (e.g., nicknames instead of legal name), which may confuse error detection algorithms used for error resolution or cause false positives or discovery. Additionally, the operational costs associated with identifying and correcting errors in these large datasets is generally very large, creating additional cost hurdles for error resolution. While additional hurdles exist for creating an effective error resolution system, there is a need for systems and methods to improve error resolution across these large and diverse datasets that effectively identifies and corrects errors in these datasets.

### SUMMARY

In some aspects, the techniques described herein relate to a method including: monitoring an identity dataset associated with one or more entities; generating a normalized and/or preprocessed dataset based on the identity dataset and an input format associated with a trained machine learning and/or LLM model; processing the normalized and/or preprocessed dataset using the trained machine learning model and/or LLM to identify one or more errors within the normalized and/or preprocessed dataset; generating a data quality score for the normalized and/or preprocessed dataset based on the one or more errors identified within the normalized and/or preprocessed dataset using the trained machine learning model; and outputting the data quality score for the normalized dataset.

In some aspects, the techniques described herein relate to a computing apparatus including: a processor; and a memory storing instructions, wherein execution of the instructions by the processor causes the processor to: monitor an identity dataset associated with one or more entities; generate a normalized dataset based on the identity dataset and an input format associated with a trained machine learning model; process the normalized dataset using the trained machine learning model to identify one or more errors within the normalized dataset; generate a data quality score for the normalized dataset based on the one or more errors identified within the normalized dataset; and output the data quality score for the normalized dataset.

In some aspects, the techniques described herein relate to a non-transitory computer-readable storage medium, the non-transitory computer-readable storage medium including instructions, wherein execution of the instructions by a processor causes the processor to: monitor an identity dataset associated with one or more entities; generate a normalized dataset based on the identity dataset and an input format associated with a trained machine learning model; process the normalized dataset using the trained machine learning model to identify one or more errors within the normalized dataset; generate a data quality score for the normalized dataset based on the one or more errors identified within the normalized dataset; and output the data quality score for the normalized dataset.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates a block diagram illustrating an error resolution system architecture, in accordance with some examples;

FIG. 2 illustrates a block diagram of a data preprocessing module for use in an error resolution system, in accordance with some examples;

FIG. 3 illustrates a block diagram of an error detection module for use in an error resolution system, in accordance with some examples;

FIG. 4 illustrates a block diagram illustrating training of, use of, and/or updating of one or more machine-learning models in the context of an error resolution system, in accordance with some examples;

FIG. 5 illustrates an exemplary user interface for an error resolution system, in accordance with some examples;

FIG. 6 illustrates an exemplary user interface for an entity for use in an error resolution system, in accordance with some examples;

FIG. 7 illustrates a flow diagram illustrating exemplary operations for a process for identity resolution, in accordance with some examples; and

FIG. 8 illustrates a block diagram of an exemplary computing device that may be used for implementing some examples of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As described above, error resolution is a critical component of many different data-related services in today's data-driven economy. Error resolution provides a way to identify and correct errors in datasets, thereby improving the quality of the data that is ingested into a system. However, as discussed, error resolution is a very difficult task for a number of reasons. To illustrate, for many systems, the complexity and size of the data being monitored for or ingested into the system creates computational hurdles for error resolution, especially when the datasets are sourced from different, unrelated data sources having their own unique data formats. In these circumstances, it is very difficult to resolve errors across the large and unique datasets, as each dataset may have its own unique errors within the format for the same entity. For example, an individual may have a birthdate of Jan. 1, 2000. However, that individual may have incorrectly entered their birthday in one system as Jan. 2, 2001, while also incorrectly entering their birthday in a separate system as Jan. 1, 2020. These different errors for the same individual highlights the difficulty and complexities in resolving errors across different, large, and unique datasets.

Additionally, the operational costs associated with identifying and correcting errors in these large datasets is generally very large, creating additional cost hurdles for error resolution. For example, in the situation above, individual identification and correction of the error would require operations for each individual error. This problem is exasperated when additional datasets are included, potentially exponentially increasing the operational costs associated with resolving these errors. Moreover, monitoring, correcting, and providing alerts for identified errors can be difficult and complex as well for many of the same reasons discussed above.

Furthermore, absent dynamic updating of records, unidentified errors become very difficult to correct once processed if not originally identified. For example, if an error is not resolved and permitted to be presented to an entity using the processed data, then that error will propagate throughout the various systems, which may negatively affect the operations of the business, entity, or individual using the processed data. As such, there is a need for systems and methods to improve error resolution across these large and diverse datasets using a comprehensive approach to monitor these large and diverse datasets, identify errors within these large and diverse datasets, and correct the errors and alert users of the error resolution system to the errors within the datasets.

The present solution disclosed herein provides a machine-learning based error resolution system that addresses at least these issues. In particular, the presently disclosed error resolution system monitors and compiles data from across these large and diverse datasets, preprocesses the data into a normalized and/or preprocessed dataset, and uses AI models to identify and correct the errors located within the datasets. Additionally, the error resolution system alerts users of the system to the errors within the dataset and determines a data quality score reflecting the quality of the data with respect to the number of errors within the data. Ultimately, the error resolution system streamlines data correction to ensure accurate information and better customer service, while reducing operational costs by automating the process of identifying and correcting data quality issues. Moreover, the active monitoring of these datasets allows data quality issues to be addressed and corrected before they negatively impact downstream systems, and also reduces the dependency on outside-sources for missing or unclear portions of the data. As such, the presently disclosed error resolution system provides proactive monitoring, identifying, alerting, and correcting of errors within large and diverse datasets while reducing the operational costs required for such a system.

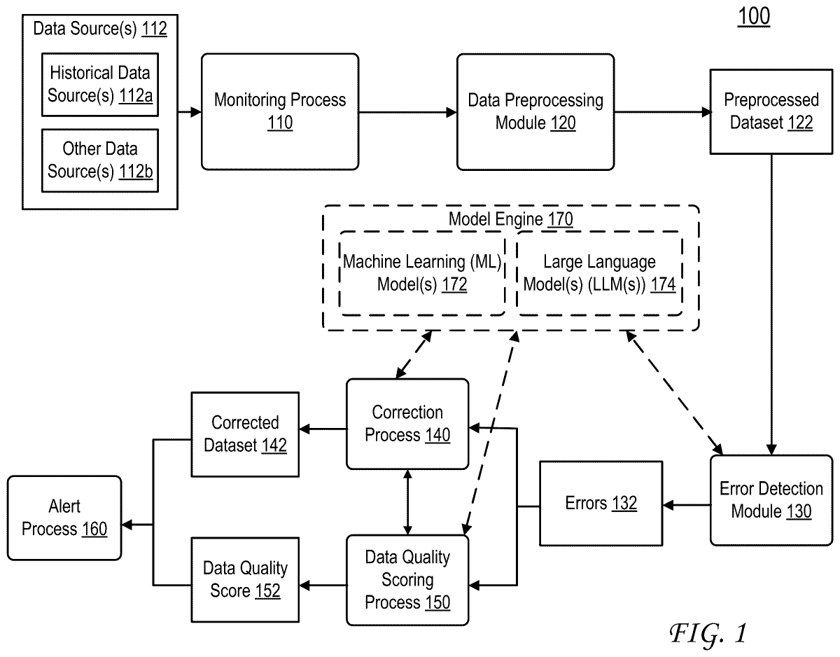

FIG. 1 illustrates an exemplary architecture for an error resolution system 100. In particular, the error resolution system 100 includes a number of processes and/or modules linked to a model engine 170. The processes generally include a monitoring process 110 for monitoring data source(s) 112, including historical data source(s) 112a and other data source(s) 112b, a data preprocessing module 120 for preprocessing the datasets into a preprocessed dataset 122, an error detection module 130 for detecting errors 132 within the datasets, a correction process 140 for correcting the errors 132 within the datasets to generate a corrected dataset 142, a quality scoring process 150 for generating a data quality score 152 for the datasets, and an alert process 160 for alerting users of the error resolution system 100 to the errors identified and/or corrected within the datasets. As shown in FIG. 1, some or all of these processes and/or modules may rely on the model engine 170 to process the datasets. The model engine 170 may include a machine-learning (ML) model(s) 172 or a large language model(s) (LLMs) 174. While this exemplary embodiment provides the ML models 172 and LLMs 174 for illustration purposes, this application is not limited to those specific models, and other types of artificial intelligence-based data-processing models may be used herein without departing from the concepts disclosed herein.

As shown in FIG. 1, each of these processes and their resulting outputs ultimately identify the errors 132 within the datasets, and correct the errors 132, generate data quality scores 152, and/or alert users of the error resolution system 100 based on the identified errors. While the exemplary embodiment shown in FIG. 1 provides an example architecture for the error resolution system 100, it is appreciated that the error resolution system 100 may take the form of other architectures, where some of the processes and/or modules may be combined, while other processes and/or modules may be added, removed, or revised. As such, the error resolution system 100 architecture of FIG. 1 is for illustration purposes only. However, for illustration purposes, each process illustrated in FIG. 1 will be discussed in turn.

First, the monitoring process 110 of the error resolution system 100 monitors and receives data, datasets, or information from data source(s) 112, including historical data source(s) 112a and other data source(s) 112b. Historical data source(s) 112a and other data source(s) 112b may include one or more database systems that capture and store historical data or other data of one or more users. Generally, historical data source(s) 112a and other data source(s) 112b may include any data source that includes user records and/or personally identifiable information (“PII”) for one or more users. Historical data source(s) 112a may generally contain historical user records or PII, while other data source(s) 112b may generally contain current user records or PII, internal user records or PII, or any other user records or PII for one or more users.

The monitoring process 110 continuously monitors and receives user records and PII from historical data source(s) 112a and other data source(s) 112b for use in the error resolution system 100. These datasets may include, but are not limited to, a user's name, date of birth, email, phone number, address, gender, social security number, etc. The aforementioned exemplary user records and PII are for illustration purposes only, as any user record or PII from historical data source(s) 112a and other data source(s) 112b may be monitored and received by monitoring process 110 of the error resolution system 100. In this manner, the error resolution system 100 monitors and receives user records and PII for the error resolution system 100 to further process and identify errors within the user records and PII, and ultimately resolve those errors.

Once the user records and PII is monitored and received by the monitoring process 110, these datasets are preprocessed by the data preprocessing module 120. As shown in FIG. 1, the data preprocessing module 120 preprocesses the user records and PII to produce preprocessed dataset 122. When the monitoring process 110 receives the user records and PII from the historical data source(s) 112a and other data source(s) 112b, it may be received in various different formats. For example, a single user may provide solely a first name for one database, a first initial and last name for another database, a first and last name for yet another database, and a first, middle, and last name for yet another database. As another example, a user may input a Dec. 31, 2000 date of birth as Dec. 31, 2000 in one database, Dec. 31, 2000 in another database, and Dec. 31, 2000 in a foreign database. As such, to efficiently and effectively process these various datasets, the error resolution system 100 uses the data preprocessing module 120 to preprocess the user records and PII from different systems into a standard format for further processing.

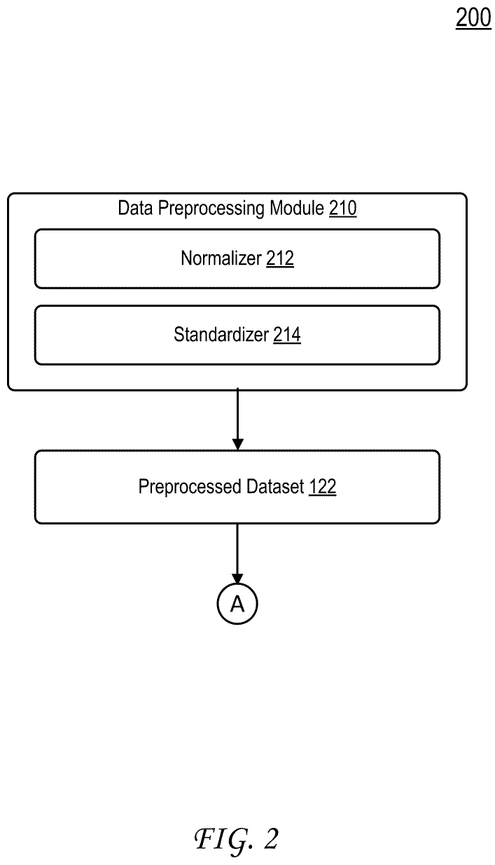

FIG. 2 illustrates an exemplary data preprocessing module architecture 200 for a data preprocessing module 210 in accordance with some examples of the present invention. In some examples, the data preprocessing module 210 is the data preprocessing module 120 illustrated in FIG. 1. As shown in FIG. 2, the data preprocessing module 210 generally includes a normalizer 212 and a standardizer 214. To illustrate the concepts disclosed herein, the data preprocessing module 210 generally includes various modules with different functions, but this architecture is for illustrative purposes. For example, multiple modules could be grouped together, individually run, or include sub-modules for performing specific functions. In this manner, various types and formats of user records and PII can be effectively and efficiently preprocessed into preprocessed dataset 122.

As shown in FIG. 2, the data preprocessing module 210 includes normalizer 212. The normalizer 212 generally normalizes the user records and PII captured by the error resolution system 100. For example, the normalizer 212 may normalize name information that is identified from the user records and PII. Once the name information is identified, the normalizer 212 extracts the name information and normalizes the name information into name fields, which may generally include a first name field, a last name field, a middle name field, and a suffix field. Once the normalizer 212 normalizes this name information, the correction process 140, discussed below, can determine whether the identified name information provides a real first and last name, a plausible first and last name, a fake first and last name, or is missing any specific name field. While the name information is used for illustrative purposes, other user records and PII may similarly be normalized by normalizer 212. When the normalizer 212 is normalizing name information, the normalizer 212 may also perform a name equivalence normalization to normalize nicknames that are captured in the monitoring process 110. For example, the normalizer 212 may normalize user nicknames to the common canonical name. To illustrate, the normalizer 212 may receive user records having nicknames based on the common root name, Robert, including Rob, Robby, Robbie, Bob, Bobby, and Bobbie. When the data preprocessing module 210 receives nickname information such as this, the normalizer 212 will normalize the nickname to the common canonical name of Robert.

The normalizer 212 of the data preprocessing module 210 may also normalize other attributes of the user records and PII monitored and received from the data source(s) 112. For example, for a date of birth field, various different systems and databases may store a date of birth for a user in various formats (e.g., Jan. 2, 2000, Jan. 2, 2000, 2020 Jan. 2, etc.). The normalizer 212 will normalize these dates into a standard format. For example, if the date of birth field is standardized to YYYY-MM-DD format by the standardizer 214 discussed further below, then the normalizer 212 will normalize the received date of birth from user records and PII to the matching standardized format. The normalizer 212 may normalize any attributes received from the user records and PII, including but not limited to name, date of birth, address, phone number, email, IP address, payment information, account identification, or any other attribute that may be received from user records and PII. Moreover, the data preprocessing module 210 may include a single normalizer 212 that is capable of normalizing each attribute received by the data preprocessing module 210, or may be separate normalizers 212 for each respective attribute. In these embodiments, each attribute will include its own normalizer for that specific attribute (e.g., a name normalizer, a date of birth normalizer, an address normalizer, etc.).

As also shown in FIG. 2, the data preprocessing module 210 also includes a standardizer 214. The standardizer 214 generally provides the functions to standardize the various PII fields that are captured by the error resolution system 100. In particular, the standardizer 214 is generally used to standardize each respective field that each piece of PII is input for further processing by the error detection module 130 and subsequent processes. For example, the standardizer 214 may standardize a phone number field by converting the field to the international standard phone number format. The standardizer 214 also may standardize a date field to a standard format (e.g., standard ISO-8601 YYYY-MM-DD format). The standardizer 214 also may standardize a timestamp field to a milliseconds standard. The standardizer 214 also may standardize a zip code field to solely focus on the first 5 digits of a US zip code. The standardizer 214 also may standardize a country code field to a standard two-letter code (e.g., ISO 3166-1 alpha-2 codes). The standardizer 214 also may standardize an email field to a standard format, such as all lowercase letters. While the aforementioned examples of standardized fields are used for illustrative purposes, the standardizer 214 may standardize any field that is used within the error resolution system 100.

Referring back to FIG. 1, the user records and PII of the user go through the data preprocessing module 120, which in some embodiments is data preprocessing module 210, to generate the preprocessed dataset 122. In particular, the preprocessed dataset 122 will include the attribute fields that were normalized and standardized by the data preprocessing module 120. Thus, the preprocessed dataset 122 provides a full view of the user records and PII of the user. Moreover, the preprocessed dataset 122 may compile various different records for the same user into a single preprocessed dataset 122 for that user. Within the preprocessed dataset 122, each attribute field will be noted as being valid and validated or as invalid. If every attribute field is valid, then the preprocessed dataset 122 for that user is likely correct and accurate and does not contain any errors, and thus is noted as being accurate and error free. However, if any attribute field is invalid or not validated, then the preprocessed dataset 122 may contain one or more errors, and moves onto the error detection module 130 to detect any errors 132.

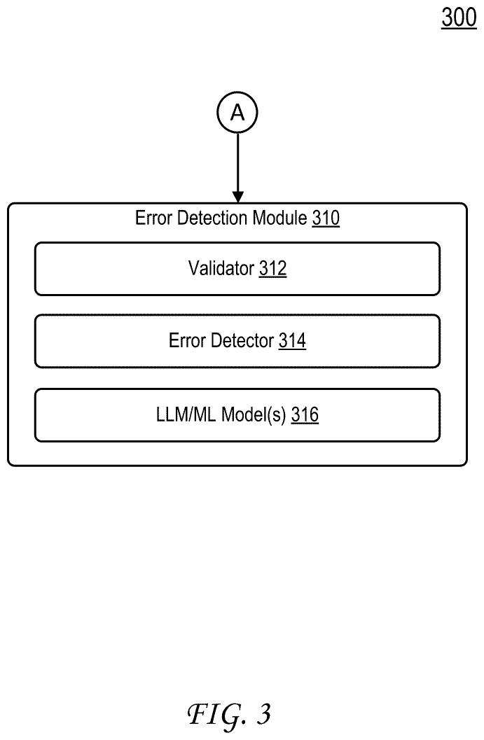

FIG. 3 illustrates an exemplary error detection module architecture 300 for an error detection module 310 in accordance with some examples of the present invention. In some examples, the error detection module 310 is the error detection module 130 illustrated in FIG. 1. As shown in FIG. 3, the error detection module 310 generally includes a validator 312, an error detector 314, and an LLM/ML model(s) 316. The LLM/ML model(s) 316 may include at least one LLM, at least one ML model (e.g., of another type other than LLM), or a combination thereof. To illustrate the concepts disclosed herein, the error detection module 310 generally includes various modules with different functions, but this architecture is for illustrative purposes. For example, multiple modules could be grouped together, individually run, or include sub-modules for performing specific functions. In this manner, the preprocessed dataset 122 can be efficiently analyzed and any errors within the preprocessed dataset 122 are detected.

The error detection module 310 may include a validator 312. The validator 312 validates the attributes received from the user records and PII to confirm they are valid. For example, the validator 312 will leverage established databases to determine whether the captured and normalized attribute fields of the preprocessed dataset 122 are valid as consistent with the established databases or are inconsistent and thus either invalid or contain an error. For example, the validator 312 may verify name information from the name fields against the social security administration database or government census database. If the plausible name fields match the information from the established databases, then the first name field or last name field (or related fields) are likely authentic. However, if the plausible name fields do not match the information from the established databases, then the name fields are marked as likely fake and marked as null, and the error resolution system 100 will use other user records and PII from other databases to fill the attribute fields.

Previously, one problem with prior error resolution systems is that when parsing attribute fields such as the name field, a misspelled name or input would be treated the same as a fake name or input, and thus marked null, even if it refers to the user's actual name or input. This was because these systems would have trouble preprocessing name records and PII from different data sources, as systems could not differentiate between fake names or inputs (e.g., a fake username such as “asfkjd”) and real names or inputs containing errors (e.g., a misspelled username such as “collleen”). This can cause additional problems during any de-duplication processes, as the information is not consistent and thus improperly not labeled as duplicative. However, the error detection module 310, using the model engine 170, differentiates between fakes and errors to solve this problem.

For example, the validator 312 may detect whether the name fields contain a fake name (e.g., a nonsense email username) or a plausible name (e.g., a misspelled first name). If the validator 312 determines the name fields contain a fake name, it is sent to an algorithmic model from model engine 170 or LLM/ML model(s) 316 for further processing or repair. If the validator 312 determines the name fields contain a plausible name, the plausible name is sent to the error detector 314, which as discussed further below, uses another model of the model engine 170 or LLM/ML model(s) 316 to obtain the most probable corrections for the plausible names.

As another example, the validator 312 may communicate with a phone number library database (e.g., Google libphonenumber library) to validate that the phone number captured in the preprocessed phone number field is an actual, existing phone number. If so, then the phone number is validated and confirmed to be an existing phone number. If not, then the phone number is either invalid or contains an error, which is noted for further processing. As another example, the validator 312 may communicate with an address or location database (e.g., AWS location services) to validate that the address captured in the preprocessed address field is an actual, existing address. If so, then the address is validated and confirmed to be an existing address. If not, then the address is either invalid or contains an error, which is noted for further processing. Moreover, these established databases and datasets may also be updated with confirmed attributes from the error resolution system 100 if the attributes are missing from the public databases.

As another example, the validator 312 may check that an email address is valid and deliverable. First, the validator 312 will check the format of the email address to confirm it contains an “@” symbol, has a valid domain name, and follows standard email address syntax rules. Then, the validator 312 will check if the domain of the email address resolves to a valid IP address by querying the Domain Name System (DNS). Then, once the domain's IP address is obtained, the validator 312 will establish a connection with the Simple Mail Transfer Protocol (SMTP) server associated with the domain and verify that the domain's server is reachable and responsive. Lastly, the validator 312 will confirm that an inbox exists for the specific username in the email address by requesting the SMTP to verify the existence of an inbox. If all four steps succeed, then the email address is valid. If any of these first three checks fail, then the email is considered invalid. However, if the first three steps are verified but a specific inbox cannot be confirmed, then the email address may be valid but contain an error or is treated as unverified.

Once the attribute fields of the preprocessed dataset 122 are processed by the validator 312, the error detection module 310 includes the error detector 314 to detect any errors 132 within the preprocessed dataset 122. In particular, the error detector 314 may use LLM/ML model(s) 316, or the ML model(s) 172 and LLM model(s) 174 of the model engine 170, to determine and identify any errors 132 within the preprocessed dataset 122. In some examples, the preprocessed dataset 122 is input into LLM/ML model(s) 316 or the model engine 170 to determine whether the unverified or invalid attribute fields are likely errors or simply fake. For example, if the date of birth attribute field provides a birthday of 2000 Jan. 2, then the date of birth is likely real and accurate. In this case, the date of birth field may be assigned a numerical value (e.g., 1) indicating that the field is accurate. If the date of birth field provides a birthday of 5555 Nov. 11, it is likely fake and invalid. In this case, the date of birth field may be assigned a numerical value (e.g., 0) indicating that the field is fake and null. However, if the date of birth field provides a birthday of 1000 Jan. 2, it is likely an error or typo, and may be assigned a numerical value in between the “accurate” and “fake” values (e.g., between 0 and 1) indicating that it is likely an error or typo.

Using the date of birth example, the error detector 314 may achieve this by determining the frequency of or relatedness to existing or verified dates of birth within the error resolution system 100 and compare the unverified or invalid date of birth field thereto. In the 1000 Jan. 2 example, the error detection module 130 may determine that the 2000 Jan. 2 birthdate is frequently verified, and 1000 Jan. 2 is only one numerical digit from 2000 Jan. 2, and therefore it is very likely that the 1000 Jan. 2 birthdate simply contains a typographical error. On the other hand, for the 5555 Nov. 11 birthdate, the error detection module 130 may determine that the 5555 year is verified at a <1% frequency and is off by a degree of at least three numerical digits. Thus, the error detection module 130 may determine that the 5555 Nov. 11 birthdate is likely invalid and fake, while the 1000 Jan. 2 birthdate is likely valid but containing an error in the birth year. In this manner, the error detector 314 can determine which attribute fields contain errors 132 for correction, and which are likely fake or invalid. The error detector 314 notes this for further processing during the correction process 140 and data quality scoring process 150.

The error detection module 310 may also include the LLM/ML model(s) 316 for processing the preprocessed dataset 122 input into the error detection module 310. The LLM/ML model(s) 316 may be the same models as the ML model(s) 172 and LLM model(s) 174 of the model engine 170, may be separate from the model engine 170. This model architecture is provided for illustration purposes only, and it is understood that other configurations of algorithmic models may be used without departing from the concepts disclosed herein.

Turning back to FIG. 1, once the errors 132 are identified by the error detection module 130, the error resolution system 100 may proceed to the correction process 140, data quality scoring process 150, or both. The correction process 140 generally corrects any errors 132 located in the preprocessed dataset 122 to create a corrected dataset 142 for the user. The data quality scoring process 150 generally scores the quality of the data contained within the preprocessed dataset 122 based on the errors 132, valid fields, and invalid fields identified within the preprocessed dataset 122. The data quality scoring process 150 may provide a data quality score 152 to a user profile containing the user information (e.g., the preprocessed dataset 122 or corrected dataset 142) so the user can view their information as well as the data quality of their information.

First, the correction process 140 will take any errors 132 identified in the preprocessed dataset 122 and, using one of the algorithmic models in the model engine 170, will correct the errors 132 to generate the corrected dataset 142. For example, the correction process 140 may correct email domains where the error detection module 130 identifies an error 132 in the domain name of the email address field. To illustrate, the error detection module 130 may determine that a “fakeperson@jmail.com” email address is within a small edit distance from a known, validated, and verified domain (e.g., “gmail.com”). The correction process 140 may then update the email address field to correct the typographical error in “jmail” such that the corrected dataset 142 instead contains the corrected “fakeperson@gmail.com” email address. While the above email domain correction is provided for illustration purposes, the correction process 140 may also correct other attribute fields that contain errors 132 as detected by the error detection module 130 using similar methods.

The correction process 140 may also categorize similar attribute fields of the preprocessed dataset 122 that need to be repaired and batch them together for processing by the model engine 170. In this way, performing the repairs will be more efficient and cost less than single batching, and simply reprocessing of other, similar attribute fields thereafter. This ultimately drives down processing costs and time, thereby providing a more effective and efficient system and method for resolving these errors in large datasets.

In some examples, the correction process 140 extracts first names and last names from email addresses or usernames using algorithmic models in the model engine 170, such as a first email parser algorithm. First, the correction process 140, using the algorithmic models, parses the username from the email address by separating the part of the email address preceding the “@” symbol. Then, the algorithmic models break down the username into different sections using non-alphanumeric separators, such as “.”, “-”, “_”, “1”, or any other non-alphanumeric separator, and assigns each section as a potential first name or last name. To illustrate, if the correction process 140 receives an email address of “jenny_doe@fakeemail.com”, the correction process 140 will identify the “jenny_doe” portion as the username, then break apart “jenny” and “doe” based on the “_” separator, thereby assigning “jenny” as a plausible first name in the first name field and “doe” as a plausible last name in the last name field. In some examples, the correction process 140 will search for specific separators (e.g., “.”) that are assigned in the data preprocessing module 120. In some examples, the data preprocessing module 120 may normalize a “jenny_doe”, “jenny7doe”, or “jenny789doe” username into a “jenny.doe” format, such that the algorithmic models in the model engine 170 receive the username data in a normalized and standardized format, thereby increasing processing efficiency and reducing processing costs and time.

The algorithmic models of the model engine 170 also include a reversal mechanism that assumes the username may have the first and last names reversed (e.g., “doe_jenny@fakeemail.com”). Thus, the algorithmic model will try to swap the parsed names and determine whether the swap provides a better fit. This decision may be based on the frequency the names appear in their respective positions in the monitored and received datasets, with a preference for finding a valid first and last name. To illustrate, if the name “jenny” is a first name with a 95% frequency while the name “doe” is a last name with a 99% frequency, then the algorithmic model may swap the “doe” and “jenny” from the “doe_jenny@fakeemail.com” email address such that “jenny” is in the first name field and “doe” is in the last name field. To accomplish this, the algorithmic models of the model engine 170 will compare the number of times “jenny” is a first name versus the number of times “jenny” is a last name in the datasets, and also compare the number of times “doe” is a last name versus the number of times “doe” is a first name. The algorithmic models of the model engine 170 will then determine a ratio using the counts and determine whether this ratio is above or below a predetermined threshold indicating that the names should be swapped. If the ratio is above the predetermined threshold, then the first and last names are swapped, but if the ratio is below the predetermined threshold, then the first and last names are left as is.

In some other examples, the correction process 140 extracts first names and last names from email addresses or usernames that do not have a separator using another algorithmic model in the model engine 170, such as a second email parser algorithm or LLM(s) 174. First, the correction process 140 parses the username from the email address by separating the part of the email address preceding the “@” symbol and creates a “newnames” column providing the username portion before the “@” symbol. For example, if the user email is “jennydoe@fakeemail.com”, the correction process 140 will extract “jennydoe” as the “newname”, then try different combinations of the string to determine the optimal name. To illustrate, in some examples, the algorithmic models, such as LLM(s) 174, will separate “jennydoe” into various combinations (e.g., jen & nydoe, jenn & ydoe, jenny & doe, jennyd & oe, etc.), and determine which combination is optimal. This may again be determined by the frequency the names appear or by verifying names with established databases. Similar to the email addresses having a separator, the algorithmic models for email addresses without separators also include the reversal mechanism to swap the first and last names should they provide a better fit. Lastly, the correction process 140, using the model engine 170, will check the returned names are valid and present in order to exclude any hallucinations. Once determined which name combination is optimal, the algorithmic model will assign the names to the plausible name fields. In some other examples, the correction process 140 will use large language models to determine the optimal name from a username. In these examples, the LLM, such as LLM(s) 174, will rely on specific prompts and examples to parse the username intelligently, and pair these prompts and examples with pre-filters and guardrails that are designed to exclude hallucinations. To illustrate, the correction process 140 may prompt the LLM, such as LLM(s) 174, to parse names from other information or words in the username, for example, by not parsing titles (e.g., Dr., Mr., Mrs., Jr., etc.), common words unlikely to be names (e.g., skater, soccer, news, career, etc.), and avoid parsing repeat characters from the username (e.g., “lucAstro” will not become “LucA” and “Astro”). In this manner, the correction process 140 can extract at least the optimal first and last name from a username having extraneous word sand information efficiently and effectively. Provided are some generic examples of optimized names (e.g., ultimately reaching the optimized name Jenny Doe) resulting from the correction process 140: (1) username: “jennydoe”→name: Jenny Doe; (2) username: “jennydoeteam”→name: Jenny Doe; (3) username: “jennyjohnsondoe”→name: Jenny Johnson Doe; (4) username: “mrsjennyjdoe”→name: Jenny J Doe; (5) username: “doejennyyyy”→name: Jenny Doe; (6) username: “soccer.jenny.D”→name: Jenny D. These examples are for illustrative purposes only and are not intended to be limiting regarding the capabilities of the correction process 140, or reflective of any actual persons or likeness.

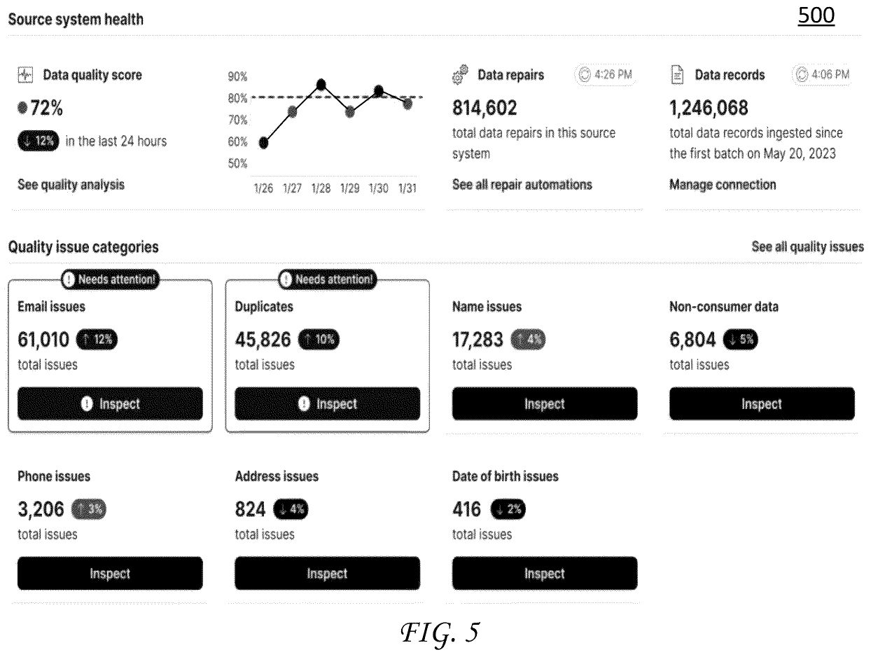

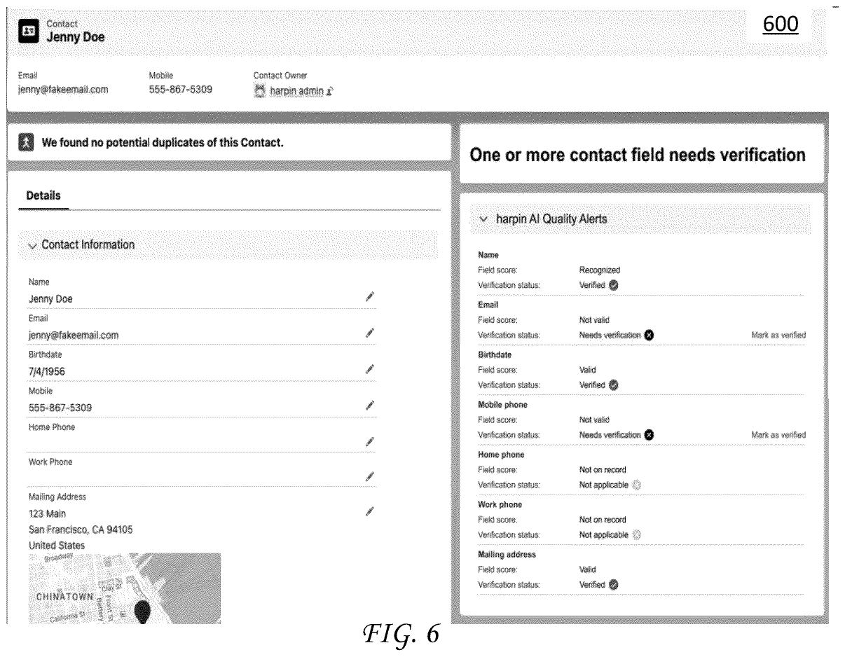

Ultimately, the correction process 140 will generate a corrected dataset 142 in which the errors 132 identified in the preprocessed dataset 122 are resolved. At this point, the corrected dataset 142 may be provided to the user interfaces illustrated by FIGS. 5 and 6 by the alert process 160, as discussed further below.

Alternatively or simultaneously, the error resolution system 100 provides a data quality scoring process 150 to score the quality of the preprocessed dataset 122 based on the authenticity and quality of the user PII contained in the attribute fields. In some examples, the data quality scoring process 150 uses the model engine 170 to perform the scoring, while in other examples, the data quality scoring process 150 may be performed by conventional methods. In this way, the data quality score 152 for the user can be provided to the user profile by the alert process 160, as discussed further below.

The data quality score 152 quantified by the data quality scoring process 150 is a single score or percentage that represents how far away the user profile deviates from a perfect profile without any errors. In some examples, the score will be in a numerical range from 0 to any number, while in other embodiments, the score may be represented by a percentage value. In embodiments using a single number for the data quality score 152, the data quality score 152 will be made up of individual attribute scores for each attribute field (e.g., the 0 to 1 numerical values discussed above). For ease of illustration, the following scoring range will be provided, but it is appreciated that other scoring ranges or systems may be used without departing from the concepts disclosed herein.

In some examples, the data quality scoring process 150 may score each attribute field between 0 and 8. In this example, the higher the number, the more errors and issues the attribute includes, while a score of 0 indicates an accurate, valid, and verified attribute. These individual attribute scores may then be summed together to generate the data quality score 152. In other examples, the data quality score 152 may be a percentage value providing the percentage of verified and validated attribute fields over attribute fields that are fake, invalid, or contain errors. In this way, the user is provided a holistic view of the quality of their data within the databases and may take further steps to increase the data quality score 152. For example, the correction process 140 may automatically correct some of the identified errors 132, which ultimately will lower the data quality score of the associated attributes, thereby lowering the data quality score 152 number if a single number or raising the data quality score 152 percentage. While the aforementioned provides some examples of data quality scoring, other ways of quantifying the quality of the data may be used in the data quality scoring process 150 without departing from the concepts disclosed herein.

As shown in FIG. 1, once the error(s) 132 are identified, and the corrected dataset 142 or data quality score 152 are generated, the alert process 160 may alert users to the corrected dataset 142, alert users to their data quality score 152, and/or provide users access to a user profile providing both the corrected dataset 142, data quality score 152, and/or any attribute fields that need further correction. In this way, the user is alerted to the quality of their data and is able to make corrections themselves, confirm the automatic corrections are correct, and maintain an accurate profile of their PII across various data source(s) 112. Additionally, as the user records and PII of the corrected dataset 142 are corrected automatically or by the user, the error resolution system 100 will capture additional verified user records and PII, which the error resolution system 100 can put back into the system to improve the algorithmic models within the model engine 170, thereby improving the efficiency and accuracy of the data preprocessing module 120, error detection module 130, correction process 140, and data quality scoring process 150 as time progresses.

In this regard, another feature of the alert process 160 is the ability to alert users about detected critical data issues as quickly as possible when those data issues are related to recent changes in the user records or PII from the data source(s) 112. For example, errors may be created over time because of changes in the data collection systems, integration with other systems, upgrades to the systems, or other changes similar in nature. Moreover, there may also be errors in the end user data collection software, errors in data processing pipelines, breakdowns in operational procedures in entering PII, fraudulent data entry, or other similar issues. As such, user record and PII are consistently changing over time, and large changes in the monitored data source(s) 112 may create large spikes of detected data issues over time, as indicated in their time series data. Thus, the alert process 160 may analyze time series data and time series data graphs associated with the monitored data source(s) 112 to determine whether the detected spike is a false alarm or reflects true data quality issues that need to be alerted and addressed.

In some examples, the alert process 160 will generate time series data based on the monitored and ingested data in the error resolution system 100. The time series data may be constructed based on hourly volume of events, daily volume of missing attribute levels, daily volume of issues being discovered, or any other way of constructing the time series data to catch different types of anomalies. In particular, the primary areas of focus for the time series data are volume at the record level, volume at the attribute level, and volume at the attribute issues (e.g., field repair) level. Other areas of focus may be used in other examples without departing from the concepts disclosed herein.

Once the time series data graphs are created, the alert process 160 can observe sudden rises or falls (e.g., sudden spikes or changes) in the time series data. These sudden changes in the time series data may indicate system integration problems, fraudulent activities, or other underlying problems that should be alerted to the users. The alert process 160 then analyzes the anomaly time series data graph against the original time series data graphs or modified time series data graphs to easily identify the potential anomalies with which the user may want to be alerted. In this manner, the alert process 160 may also alert users to the detected critical data quality issues as quickly as possible, while simultaneously maintaining accuracy in the detected issues and not alerting users to false positives.

As such, the alert process 160 of the error resolution system 100 acts to provide the corrected dataset 142 and data quality score 152 to the user profile associated with the user for their individual attributes as well as overall user profile, as well as alerting users to critical data issues across their entire datasets based on the time series data collectively. In this regard, the alert process 160 quickly, efficiently, and accurately alerts users to issues spanning from individual attribute errors to errors across an entire database of the user.

In some examples, the alert process 160 may provide the corrected dataset 142, data quality score 152, and/or time series data to the user interface illustrated in FIG. 5, or the user interface illustrated in FIG. 6. As such, the alert process 160 ultimately alerts the user to the errors 132, corrected dataset 142, and data quality score 152 for their user profile, as well as the overall health of the user's monitored database. Therefore, the error resolution system 100 is capable of efficiently and effectively monitoring user records and PII from data source(s) 112, identifying errors 132 and issues within those user records and PII, generate a corrected dataset 142 and data quality score 152 for those user records and PII, and ultimately alert the user to their errors 132, critical data issues, corrected dataset 142 and data quality score 152.

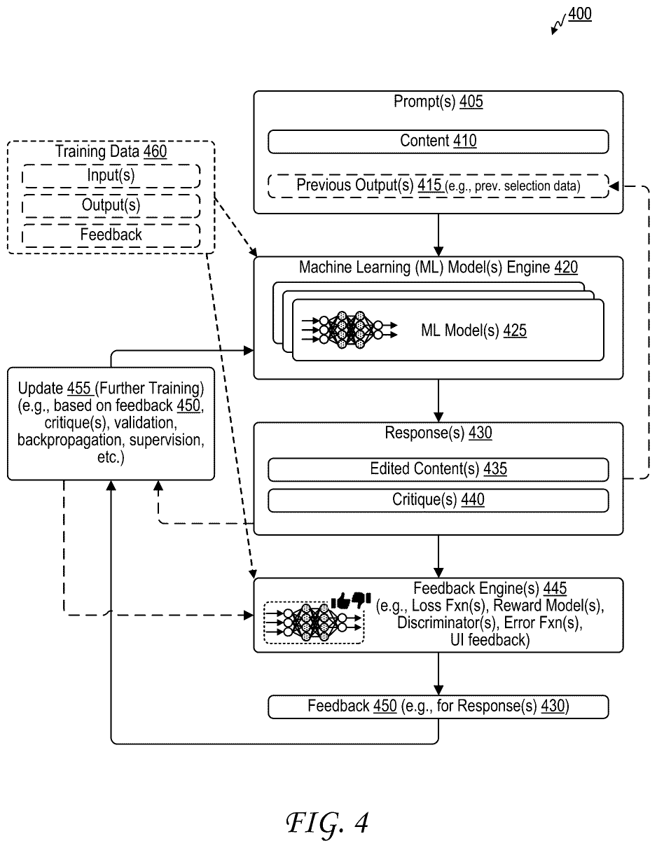

FIG. 4 is a block diagram illustrating training of, use of, and/or updating of one or more machine learning (ML) models 425 in the context of a content processing technique 400 for use with the error resolution system 100. The content processing technique 400 includes a ML engine 420 for training, using, and/or updating one or more ML models 425. The ML model(s) 425 can include, for example, any algorithmic models of model engine 170, ML model(s) 172, LLM model(s) 174, error detection module 130, ML/LLM model(s) 316, correction process 140, data quality scoring process 150, or a combination thereof.

A prompt 405 can be passed to the ML model(s) 425 of the ML engine 420, and input into the ML model(s) 425. In some examples, the prompt 405 includes or identifies content 410 to be critiqued and/or edited, and the ML model(s) 425 (e.g., functioning as the any algorithmic model in or attached to model engine 170) output, in a response 430, critique(s) 440 of the content 410 in the prompt 405. In some examples, the prompt 405 includes or identifies previous output(s) 415 (e.g., the critique(s) 440 generated in a previous round) of the content 410 to be edited, and the ML model(s) 425 edits the content 410 from the prompt 405 based on the previous output(s) 415 form the prompt 405 to generate and output, in a response 430, edited content 435 that has been edited based on the previous output(s) 415 in the prompt 405. In some examples, the prompt 405 may include a query or another type of input. In some examples, the prompt 405 may be referred to as the input to the ML model(s) 425. In some examples, the response(s) 430 may be referred to as the output(s) of the ML model(s) 425.

In some examples, the content processing technique 400 includes feedback engine(s) 445 that can analyze the response 430 (e.g., the edited content 435 and/or the critique(s) 440) to determine feedback 450, for instance as discussed with respect to the error detection module 130. In some examples, the feedback 450 indicates how well the response(s) 430 align to corresponding expected response(s) and/or output(s), how well the response(s) 430 serve their intended purpose, or a combination thereof. In some examples, the feedback engine(s) 445 include loss function(s), reward model(s) (e.g., other ML model(s) that are used to score the response(s) 430), discriminator(s), error function(s) (e.g., in back-propagation), user interface feedback received via a user interface from a user, or a combination thereof. In some examples, the feedback 450 can include one or more alignment score(s) that score a level of alignment between the response(s) 430 and the expected output(s) and/or intended purpose.

The ML engine 420 can use the feedback 450 to generate an update 455 to update (further train and/or fine-tune) the ML model(s) 425. The ML engine 420 can use the update 455 to update (further train and/or fine-tune) the ML model(s) 425 based on the feedback 450, based on feedback in further prompts or responses from a user (e.g., received via a user interface such as a chat interface), critique(s) (e.g., previous output(s) 415, critique(s) 440), validation (e.g., based on how well the edited content 435 and/or the critique(s) 440 match up with predetermined edited content and/or critiques), other feedback, or combinations thereof.

The ML model(s) 425 can have been initially trained by the ML engine 420 using training data 460 during an initial training phase, before receiving the prompt 405. The training data 460, in some examples, includes examples of prompt(s) (e.g., as in prompt 405), examples of response(s) (e.g., response 430) to the example prompt(s), and/or examples of alignment scores for the example response(s). In some examples, the ML engine 420 can use the training data 460 to perform fine-tuning and/or updating of the ML model(s) 425 (e.g., as discussed with respect to the update 455 or otherwise). In some examples, for instance, the ML engine 420 can start with ML model(s) 425 that are pre-trained with some initial training, and can use the training data 460 to update and/or fine-tune the ML model(s) 425.

In some examples, if feedback 450 (and/or other feedback) is positive (e.g., expresses, indicates, and/or suggests approval, accuracy, and/or quality), then the ML engine 420 performs the update 455 (further training and/or fine-tuning) of the ML model(s) 425 by updating the ML model(s) 425 to reinforce weights and/or connections within the ML model(s) 425 that contributed to the response(s) 430 that received the positive feedback 450 or feedback, encouraging the ML model(s) 425 to continue generating similar responses to similar prompts moving forward. In some examples, if feedback 450 (and/or other feedback) is negative (e.g., expresses, indicates, and/or suggests disapproval, inaccuracy, errors, mistakes, omissions, bugs, crashes, and/or lack of quality), then the ML engine 420 performs the update 455 (further training and/or fine-tuning) of the ML model(s) 425 by updating the ML model(s) 425 to weaken, remove, and/or replace weights and/or connections within the ML model(s) 425 that contributed to the response(s) 430 that received the negative feedback 450 or feedback, discouraging the ML model(s) 425 from generating similar responses to similar prompts moving forward.

FIG. 5 illustrates an exemplary user interface of a data source profile 500 providing the overall source system health for records received from one data source 112. In particular, the user interface illustrated in FIG. 5 provides the data source profile 500 for every user record and PII from that specific data source 112 after it has run through the error resolution system 100. As shown in FIG. 5, the data source profile 500 includes an overall source system health, which provides the data quality score 152 (in percentage format in this example), a graph illustrating the changes in the data quality score over time (e.g., time series data graph), the total number of data repairs automatically performed by the error resolution system 100, and the total number of data records ingested by the error resolution system 100 since a predetermined date. The total data records ingested represents the total number of user records and PII that the monitoring process 110 monitors and receives from data source(s) 112 over time. As the monitoring process 110 continuously monitors and receives user records and PII from the data source(s) 112, this data records number is continuously updated. The data repairs number represents the total number of records and PII that are automatically repaired by correction process 140. In this example, the data quality score 152 is a percentage of the total number of repaired and verified user records and PII over the total number of data records, while the graph provides an outlook of the data quality score 152 over time.

Under the source system health portion is a quality issues categories section that provides the specific issues and errors for specific attributes. For example, as shown in FIG. 5, of the 1.2 M records, there are a total of 61,010 issues and errors with email, 45,826 duplicative entries, 17,283 name issues, 6,804 data that is not associated with a consumer, 3,206 phone number issues, 824 address issues, and 416 date of birth issues. A user may inspect each specific category of issue to review the specific records that contain the issues, errors, or invalid entries. Moreover, the largest issues are further highlighted for alerting the user to major issues with their data source. In this manner, a database entity may use the error resolution system 100 to monitor all of its user data and PII, identify the errors therein, resolve those errors, and have a holistic view of their entire database through data source profile 500. While the aforementioned orientation of the data source profile 500 is used for illustrative purposes, other attributes may be included, and the specific arrangement of sections of the data source profile 500 may be altered without departing from the concepts disclosed herein.

FIG. 6 illustrates an exemplary user interface of a user profile 600 providing the user records and PII for a specific user, in this example, Jenny Doe. In particular, the user profile 600 provides the corrected dataset 142 for that specific user, any alerts regarding the validity of her information, and in some other examples, the data quality score associated with the user profile 600. In the exemplary user profile 600 illustrated by FIG. 6, the user is Jenny Doe, and the user profile 600 includes the attribute fields from her corrected dataset 142. Each attribute field also includes a field score and verification status to indicate whether that specific attribute field is valid and verified, or is invalid and needs verification, updating, or correction. For example, for Jenny Doe's name, the field score is “recognized” and the verification status is “verified.” This “recognized” status indicates that the error resolution system 100 determined the name attribute field contained accurate information, did not contain any errors, and was verified against an established database, as described above. The “verified” status indicates that an external entity (e.g., a customer service representative) verified the name is accurate and spelled correctly. Thus, here, this specific attribute field is both “recognized” by the error resolution system 100 and independently “verified” by an external entity. However, the next attribute field, email address, is “jenny@fakeemail.com”. Here, the user profile 600 indicates that the field score for Jenny's email is “not valid” and “needs verification”. This indicates that Jenny's email address was found to have issues within the email, whether the issues be from errors in the name, failure to respond to domain, or failure to have an inbox associated with the email address, as described above. As such, the user profile 600 provides a holistic view of the data quality associated with a specific user.

The user profile 600 is provided for illustrative purposes, and the content and arrangement of the elements may be altered without departing from the concepts disclosed herein. For example, the “details” section and “Quality Alerts” sections may be swapped. Alternatively, the field score for each attribute field may provide the attribute quality score instead of the shown “recognized”, “not valid” or “not on record” tags. Moreover, while not shown in FIG. 6, the data quality score 152 for that specific user may also be provided in the user profile 600 without departing from the concepts disclosed herein.

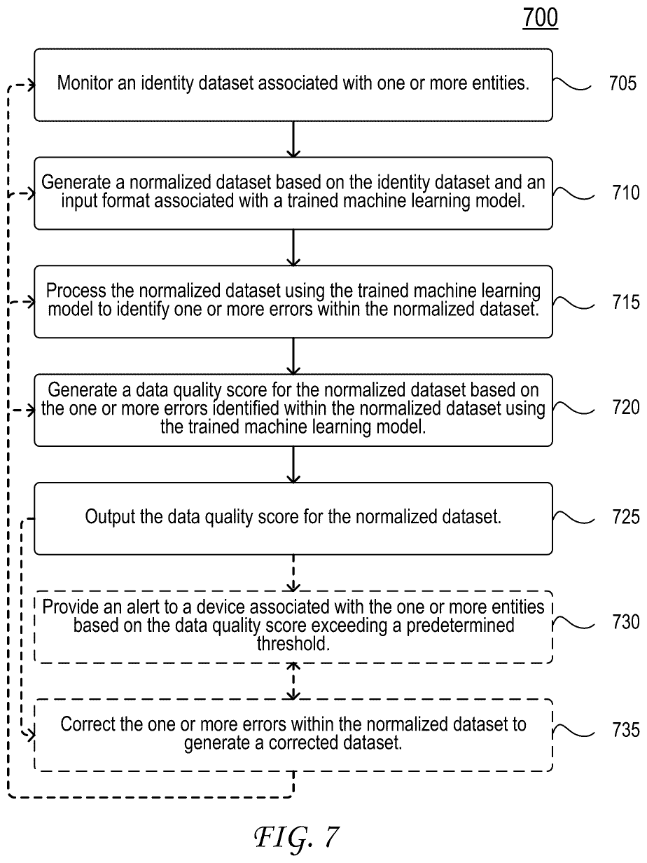

FIG. 7 illustrates a flow diagram illustrating exemplary operations for a process 700 for error resolution. The process 700 may be referred to as a method for error resolution. The process 700 may be performed by an error resolution system. In some examples, the error resolution system can include, for instance, the error resolution system 100, the data source(s) 112, the model engine 170, the ML model(s) 172, the LLM(s) 174, the exemplary data preprocessing module architecture 200, the error detection module architecture 300, the LLM/ML model(s) 316, the content processing technique 400, the ML engine 420, the ML model(s) 425, the feedback engine(s) 445, a system associated with the data source profile 500, a system associated with the user profile 600, the computing system 800, a non-transitory computer-readable storage medium storing instructions that perform the process 700 when executed by a processor such as processor 810, other components described herein, substitutes for any of these components, sub-components of any of these components, or a combination thereof.

At operation 705, the error resolution system monitors (e.g., via the monitoring process 110) an identity dataset associated with one or more entities. In some examples, the identity dataset is associated with the data source(s) 112.

At operation, 710, the error resolution system generates (e.g., via the data preprocessing module 120 and/or the exemplary data preprocessing module architecture 200) a normalized dataset (e.g., preprocessed dataset 122) based on the identity dataset and/or based on an input format associated with a trained machine learning (ML) model. In some examples, the error resolution system may generate a preprocessed dataset based on the identity dataset and/or based on an input format associated with a trained ML model. Examples of the trained machine learning model include the ML model(s) 172, the LLM(s) 174, the LLM/ML model(s) 316, the ML model(s) 425, another ML model discussed herein, or a combination thereof.

At operation, 715, the error resolution system processes the normalized dataset using the trained machine learning model to identify (e.g., via the ML model engine 170, the error detection module 130, and/or the LLM/ML model(s) 316 of the error detection module 310) one or more errors (e.g., errors 132) within the normalized dataset. In some examples, the response(s) 430 (e.g., the critique(s) 440) include identification of the one or more error(s).

At operation, 720, the error resolution system generates (e.g., via the data quality scoring process 150) a data quality score for the normalized dataset based on the one or more errors identified within the normalized dataset. In some examples, the error resolution system processes the normalized dataset and/or the one or more errors using the trained ML model (or another trained ML model) to identify the data quality score for the normalized dataset.

In some examples, generating the data quality score (as in operation 720) includes, and/or is based on, the error resolution system analyzing the normalized dataset and the one or more errors using a second trained machine learning (ML) model to generate the data quality score. Examples of the second trained ML model include the ML model(s) 172, the LLM(s) 174, the LLM/ML model(s) 316, the ML model(s) 425, another ML model discussed herein, or a combination thereof.

At operation, 725, the error resolution system outputs the data quality score for the normalized dataset, for instance using the alert process 160, the response(s) 430, a user interface associated with the data source profile 500, a user interface associated with the user profile 600, another user interface or notification or communication, or a combination thereof.

At operation, 730, the error resolution system provides an alert to a device associated with the one or more entities based on the data quality score exceeding a predetermined threshold, for instance using the alert process 160, the response(s) 430, a user interface associated with the data source profile 500, a user interface associated with the user profile 600, another user interface or notification or communication, or a combination thereof.

At operation, 735, the error resolution system corrects (e.g., via the correction process 140) the one or more errors within the normalized dataset to generate a corrected dataset (e.g., the corrected dataset 142). In some examples, the process 700 returns from operation 735 to any of operation 705, operation 710, operation 715, or operation 720, using the corrected dataset 142 in place of the identity dataset or normalized dataset of those operations. For instance, in some examples, the error resolution system generates (e.g., via the data quality scoring process 150) an adjusted data quality score (e.g., data quality score 152) based on the corrected dataset (e.g., returning from operation 735 to operation 720). In some examples, the adjusted data quality score differs from the data quality score.

In some examples, the error resolution system dynamically updates the normalized dataset (e.g., in real-time or near real-time) as data in the identity dataset continues to be monitored (e.g., continues to be received, tracked, parsed, and/or analyzed) over time. In some examples, the error resolution system dynamically identifies at least one additional error in the normalized dataset (e.g., in real-time or near real-time) as the data in the identity dataset continues to be monitored (e.g., continues to be received, tracked, parsed, and/or analyzed) over time. In some examples, the error resolution system dynamically updates the data quality score for the normalized dataset (e.g., in real-time or near real-time) as the data in the identity dataset continues to be monitored (e.g., continues to be received, tracked, parsed, and/or analyzed) over time.

In some examples, the error resolution system provides a user interface to the one or more entities (e.g., to one or more devices associated with the one or more entities). The user interface provides the data quality score and the one or more errors within the normalized dataset. Examples of the user interface include the alert of the alert process 160, a user interface that outputs at least a subset of response(s) 430, a user interface associated with the data source profile 500, a user interface associated with the 600/, or a combination thereof.

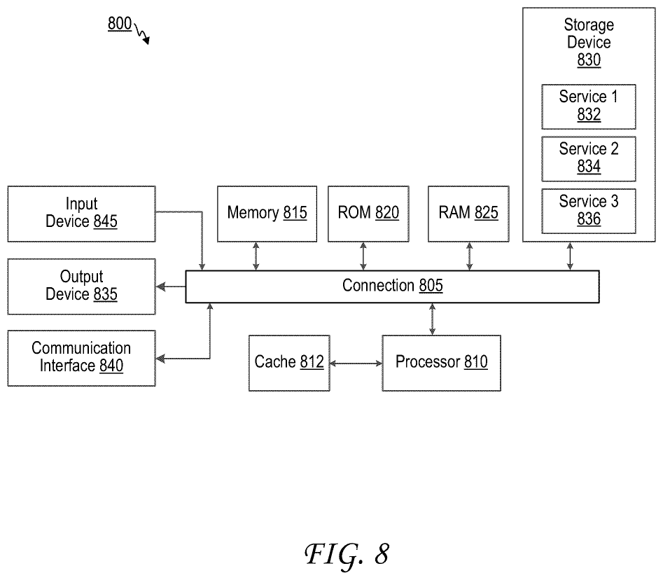

FIG. 8 shows an exemplary computing system 800, which may be used to implement some aspects of the technology disclosed herein. For example, any of the computing devices, computing systems, network devices, network systems, and/or servers described herein may include at least one computing system 800, or may include at least one component of the computing system 800 identified in FIG. 8. The computing system of FIG. 8 includes a connection 805 which can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

The example computing system 800 includes at least one processing unit (CPU or processor) 810 and connection 805 that couples various system components including system memory 815, such as read-only memory (ROM) 820 and random access memory (RAM) 825 to processor 810. The computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric. The processor 810 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 810 may include one or more cores, either integrated onto a single chip or spread across multiple chips connected or coupled together. Memory 815 stores, in part, instructions and data for execution by processor 810. Memory 815 can store the executable code when in operation.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se. Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Aspect 1. A method comprising: monitoring an identity dataset associated with one or more entities; generating a normalized dataset based on the identity dataset and an input format associated with a trained machine learning model; processing the normalized dataset using the trained machine learning model to identify one or more errors within the normalized dataset; generating a data quality score for the normalized dataset based on the one or more errors identified within the normalized dataset using the trained machine learning model; and outputting the data quality score for the normalized dataset.

Aspect 2. The method of aspect 1, further comprising: providing an alert to a device associated with the one or more entities based on the data quality score exceeding a predetermined threshold.

Aspect 3. The method of aspect 1, further comprising: correcting the one or more errors within the normalized dataset to generate a corrected dataset.

Aspect 4. The method of aspect 3, further comprising: generating an adjusted data quality score based on the corrected dataset, wherein the adjusted data quality score differs from the data quality score.

Aspect 5. The method of aspect 1, wherein generating the data quality score includes analyzing the normalized dataset and the one or more errors using a second trained machine learning model to generate the data quality score.

Aspect 6. The method of aspect 1, further comprising: dynamically updating the normalized dataset as data in the identity dataset continues to be monitored over time; dynamically identifying at least one additional error in the normalized dataset as the data in the identity dataset continues to be monitored over time; and dynamically updating the data quality score for the normalized dataset as the data in the identity dataset continues to be monitored over time.

Aspect 7. The method of aspect 1, further comprising: providing a user interface to the one or more entities, the user interface providing the data quality score and the one or more errors within the normalized dataset.

Aspect 8. A computing apparatus comprising: a processor; and a memory storing instructions, wherein execution of the instructions by the processor causes the processor to: monitor an identity dataset associated with one or more entities; generate a normalized dataset based on the identity dataset and an input format associated with a trained machine learning model; process the normalized dataset using the trained machine learning model to identify one or more errors within the normalized dataset; generate a data quality score for the normalized dataset based on the one or more errors identified within the normalized dataset; and output the data quality score for the normalized dataset.

Aspect 9. The computing apparatus of aspect 8, wherein the execution of the instructions causes the processor to: provide an alert to a device associated with the one or more entities based on the data quality score exceeding a predetermined threshold.

Aspect 10. The computing apparatus of aspect 8, wherein the execution of the instructions causes the processor to: correct the one or more errors within the normalized dataset to generate a corrected dataset.

Aspect 11. The computing apparatus of aspect 10, wherein the execution of the instructions causes the processor to: generate an adjusted data quality score based on the corrected dataset, wherein the adjusted data quality score differs from the data quality score.

Aspect 12. The computing apparatus of aspect 8, wherein, to generate the data quality score, the execution of the instruction causes the processor to: analyze the normalized dataset and the one or more errors using a second trained machine learning model to generate the data quality score.

Aspect 13. The computing apparatus of aspect 8, wherein the execution of the instructions causes the processor to: dynamically update the normalized dataset as data in the identity dataset continues to be monitored over time; dynamically identify at least one additional error in the normalized dataset as the data in the identity dataset continues to be monitored over time; and dynamically update the data quality score for the normalized dataset as the data in the identity dataset continues to be monitored over time.

Aspect 14. The computing apparatus of aspect 8, wherein the execution of the instructions causes the processor to: provide a user interface to the one or more entities, the user interface providing the data quality score and the one or more errors within the normalized dataset.

Aspect 15. A non-transitory computer-readable storage medium, the non-transitory computer-readable storage medium including instructions, wherein execution of the instructions by a processor causes the processor to: monitor an identity dataset associated with one or more entities; generate a normalized dataset based on the identity dataset and an input format associated with a trained machine learning model; process the normalized dataset using the trained machine learning model to identify one or more errors within the normalized dataset; generate a data quality score for the normalized dataset based on the one or more errors identified within the normalized dataset; and output the data quality score for the normalized dataset.

Aspect 16. The non-transitory computer-readable storage medium of aspect 15, wherein the execution of the instructions causes the processor to: provide an alert to a device associated with the one or more entities based on the data quality score exceeding a predetermined threshold.

Aspect 17. The non-transitory computer-readable storage medium of aspect 15, wherein the execution of the instructions causes the processor to: correct the one or more errors within the normalized dataset to generate a corrected dataset.

Aspect 18. The non-transitory computer-readable storage medium of aspect 17, wherein the execution of the instructions causes the processor to: generate an adjusted data quality score based on the corrected dataset, wherein the adjusted data quality score differs from the data quality score.

Aspect 19. The non-transitory computer-readable storage medium of aspect 15, wherein, to generate the data quality score, the execution of the instructions causes the processor to: analyze the normalized dataset and the one or more errors using to second trained machine learning model to generate the data quality score.

Aspect 20. The non-transitory computer-readable storage medium of aspect 15, wherein the execution of the instructions causes the processor to: dynamically update the normalized dataset as data in the identity dataset continues to be monitored over time; dynamically identify at least one additional error in the normalized dataset as the data in the identity dataset continues to be monitored over time; and dynamically update the data quality score for the normalized dataset as the data in the identity dataset continues to be monitored over time.

What is claimed is:

1. A method comprising:
monitoring an identity dataset associated with one or more entities;
generating a normalized dataset based on the identity dataset and an input format associated with a trained machine learning model;
processing the normalized dataset using the trained machine learning model to identify one or more errors within the normalized dataset;
generating a data quality score for the normalized dataset based on the one or more errors identified within the normalized dataset using the trained machine learning model; and
outputting the data quality score for the normalized dataset.

2. The method of claim 1, further comprising:
providing an alert to a device associated with the one or more entities based on the data quality score exceeding a predetermined threshold.

3. The method of claim 1, further comprising:
correcting the one or more errors within the normalized dataset to generate a corrected dataset.

4. The method of claim 3, further comprising:
generating an adjusted data quality score based on the corrected dataset, wherein the adjusted data quality score differs from the data quality score.

5. The method of claim 1, wherein generating the data quality score includes analyzing the normalized dataset and the one or more errors using a second trained machine learning model to generate the data quality score.

6. The method of claim 1, further comprising:
dynamically updating the normalized dataset as data in the identity dataset continues to be monitored over time;
dynamically identifying at least one additional error in the normalized dataset as the data in the identity dataset continues to be monitored over time; and
dynamically updating the data quality score for the normalized dataset as the data in the identity dataset continues to be monitored over time.

7. The method of claim 1, further comprising:
providing a user interface to the one or more entities, the user interface providing the data quality score and the one or more errors within the normalized dataset.

8. A computing apparatus comprising:
a processor; and
a memory storing instructions, wherein execution of the instructions by the processor causes the processor to:
monitor an identity dataset associated with one or more entities;
generate a normalized dataset based on the identity dataset and an input format associated with a trained machine learning model;
process the normalized dataset using the trained machine learning model to identify one or more errors within the normalized dataset;
generate a data quality score for the normalized dataset based on the one or more errors identified within the normalized dataset; and
output the data quality score for the normalized dataset.

9. The computing apparatus of claim 8, wherein the execution of the instructions causes the processor to:
provide an alert to a device associated with the one or more entities based on the data quality score exceeding a predetermined threshold.

10. The computing apparatus of claim 8, wherein the execution of the instructions causes the processor to:
correct the one or more errors within the normalized dataset to generate a corrected dataset.

11. The computing apparatus of claim 10, wherein the execution of the instructions causes the processor to:
generate an adjusted data quality score based on the corrected dataset, wherein the adjusted data quality score differs from the data quality score.

12. The computing apparatus of claim 8, wherein, to generate the data quality score, the execution of the instruction causes the processor to:
analyze the normalized dataset and the one or more errors using a second trained machine learning model to generate the data quality score.

13. The computing apparatus of claim 8, wherein the execution of the instructions causes the processor to:
dynamically update the normalized dataset as data in the identity dataset continues to be monitored over time;
dynamically identify at least one additional error in the normalized dataset as the data in the identity dataset continues to be monitored over time; and
dynamically update the data quality score for the normalized dataset as the data in the identity dataset continues to be monitored over time.

14. The computing apparatus of claim 8, wherein the execution of the instructions causes the processor to:
provide a user interface to the one or more entities, the user interface providing the data quality score and the one or more errors within the normalized dataset.

15. A non-transitory computer-readable storage medium, the non-transitory computer-readable storage medium including instructions, wherein execution of the instructions by a processor causes the processor to:
monitor an identity dataset associated with one or more entities;
generate a normalized dataset based on the identity dataset and an input format associated with a trained machine learning model;
process the normalized dataset using the trained machine learning model to identify one or more errors within the normalized dataset;
generate a data quality score for the normalized dataset based on the one or more errors identified within the normalized dataset; and
output the data quality score for the normalized dataset.

16. The non-transitory computer-readable storage medium of claim 15, wherein the execution of the instructions causes the processor to:
provide an alert to a device associated with the one or more entities based on the data quality score exceeding a predetermined threshold.

17. The non-transitory computer-readable storage medium of claim 15, wherein the execution of the instructions causes the processor to:
correct the one or more errors within the normalized dataset to generate a corrected dataset.

18. The non-transitory computer-readable storage medium of claim 17, wherein the execution of the instructions causes the processor to:
generate an adjusted data quality score based on the corrected dataset, wherein the adjusted data quality score differs from the data quality score.

19. The non-transitory computer-readable storage medium of claim 15, wherein, to generate the data quality score, the execution of the instructions causes the processor to:
analyze the normalized dataset and the one or more errors using to second trained machine learning model to generate the data quality score.

20. The non-transitory computer-readable storage medium of claim 15, wherein the execution of the instructions causes the processor to:
dynamically update the normalized dataset as data in the identity dataset continues to be monitored over time;
dynamically identify at least one additional error in the normalized dataset as the data in the identity dataset continues to be monitored over time; and
dynamically update the data quality score for the normalized dataset as the data in the identity dataset continues to be monitored over time.
